(19) United States
(12) Patent Application Publication
(10) Pub. No.: US 2010/0228554 A1
(43) Pub. Date: Sep. 9, 2010

(54) MULTI-OBJECT AUDIO ENCODING AND DECODING METHOD AND APPARATUS THEREOF

(75) Inventors: Seungkwon Beack, Daejon (KR); Jeong-Il Seo, Daejon (KR); Kyeongok Kang, Daejon (KR); Jinwoo Hong, Daejon (KR); Jinwoong Kim, Daejon (KR); Taejin Lee, Daejon (KR)

Correspondence Address: LADAS & PARRY LLP, 224 SOUTH MICHIGAN AVENUE, SUITE 1600, CHICAGO, IL, 60604, US

(73) Assignee: Electronics and Telecommunications Research Institute, Daejeon (KR)

(21) Appl. No.: 12/682,914

(22) PCT Filed: Oct. 21, 2008
(86) PCT No.: PCT/KR08/06226

§ 371 Date: Apr. 14, 2010

(30) Foreign Application Priority Data
Oct. 22, 2007 (KR) 10-2007-0106067
Jan. 9, 2008 (KR) 10-2008-0002759

(51) Int. Cl. G10L 19/00

(52) U.S. Cl. 704/500; 704/E19.001

(57) ABSTRACT

Provided are a multi-object audio encoding and decoding method and an apparatus thereof. The multi-object encoding method includes generating a down-mix signal and a residual signal by down-mixing a foreground audio object and a background audio object, and generating a bitstream including the down-mix signal and the residual signal.

### TECHNICAL FIELD

The present invention relates to an audio encoding and decoding method and an apparatus thereof; and, more particularly, to a multi-object audio encoding and decoding method and an apparatus thereof.

This work was supported by the IT R&D program of MIC/IITA [2007-S-004-01, “Development of Glassless Single-User3D Broadcasting Technologies”].

### BACKGROUND ART

A space queue based spatial audio coding (SAC) method was introduced as a method for compressing and restoring audio signals according to the related art. The SAC method was a technology developed for multi-channel audio encoding.

In general, conventional audio technologies have a functional limitation that only allows users to passively listen audio contents. Therefore, the conventional audio technologies could not provide various audio services to a user.

### DISCLOSURE

### Technical Problem

An embodiment of the present invention is directed to providing a coding and decoding method for effectively providing various audio services, and an apparatus thereof.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a multi-object encoding method including generating a down-mix signal and a residual signal by down-mixing a foreground audio object and a background audio object, and generating a bitstream including the down-mix signal and the residual signal.

In accordance with another aspect of the present invention, there is provided a multi-object audio encoding method including generating a down-mix signal and a residual signal by down-mixing an mono foreground audio object to a mono background audio object, and generating a bitstream including the down-mix signal and the residual signal.

In accordance with another aspect of the present invention, there is provided a multi-object encoding method including generating a down-mix signal and a residual signal by down-mixing a stereo foreground audio object and a mono background audio object, and generating a bitstream including the down-mix signal and the residual signal.

In accordance with another aspect of the present invention, there is provided a multi-object audio encoding method including generating a down-mix signal and a residual signal by down-mixing a stereo foreground audio object and a stereo background audio object, and generating a bitstream including the down-mix signal and the residual signal.

In accordance with another aspect of the present invention, there is provided a multi-object audio decoding method, including receiving a bitstream including a down-mix signal generated by down-mixing a foreground audio object and a background audio object and a residual signal generated according to the down-mixing, and restoring the foreground audio object and the background audio object from the down-mix signal using the residual signal.

In accordance with another aspect of the present invention, there is provided a multi-object audio decoding method, including receiving a bitstream including a down-mix signal generated by down-mixing a mono foreground audio object and a mono background audio object and a residual signal left after the down-mixing, and restoring the foreground audio object and the background audio object from the down-mix signal using the residual signal.

In accordance with another of the present invention, there is provided a multi-object audio decoding method including receiving a down-mix signal generated by down-mixing a stereo foreground audio object and a mono background audio object and a residual signal left after the down-mixing, and restoring the stereo foreground audio object and the mono background audio object using the residual signal.

In accordance with another aspect of the present invention, there is provided a multi-object audio decoding method, including receiving a bitstream including a down-mix signal by down-mixing a stereo foreground audio object and a stereo background audio object and a residual signal according to the down-mix signal, and restoring the stereo foreground audio object and the stereo background audio object from the down-mix signal using the residual signal.

In accordance with another aspect of the present invention, there is provided a multi-object audio encoding apparatus including a down-mix generator for generating a down-mix signal and a residual signal by down-mixing an foreground audio object and a background audio object, and generating a bitstream including the down-mix signal and the residual signal.

In accordance with another aspect of the present invention, there is provided a multi-object audio encoding apparatus including a down-mix generator for generating a down-mix signal and a residual signal by down-mixing an mono foreground audio object and a mono background audio object, and a bitstream generator for generating a bitstream including the down-mix signal and the residual signal.

In accordance with another aspect of the present invention, there is provided a multi-object audio encoding apparatus including a down-mix generator for generating a down-mix signal and a residual signal by down-mixing a stereo foreground audio object and a mono background audio object, and a bitstream generator for generating a bitstream including the down-mix signal and the residual signal.

In accordance with another aspect of the present invention, there is provided a multi-object audio encoding apparatus including a down-mix generator for generating a down-mix signal and a residual signal by down-mixing a stereos foreground audio object and a stereo background audio object, and a bitstream generator for generating a bitstream including the down-mix signal and the residual signal.

In accordance with another aspect of the present invention, there is provided a multi-object audio decoding apparatus including a receiver for receiving a bitstream including a down-mix signal generated by down-mixing a foreground audio object and a background audio object and a residual signal generated according to the down-mix signal, and a restorer for restoring the foreground audio object and the background audio object from the down-mix signal using the residual signal.

In accordance with another aspect of the present invention, there is provided a multi-object audio decoding apparatus including a receiver for receiving a bitstream including a down-mix signal generated by down-mixing a mono foreground audio object and a mono background audio object and a residual signal generated according to the down-mix signal, and a restorer for restoring the mono foreground audio object and the mono background audio object from the down-mix signal using the residual signal.

In accordance with another aspect of the present invention, there is provided a multi-object audio decoding apparatus including a receiver for receiving a bitstream including a down-mix signal generated by down-mixing a stereo foreground audio object and a mono background audio object and a residual signal generated according to the down-mix signal, and a restorer for restoring the stereo foreground audio object and the mono background audio object from the down-mix signal using the residual signal.

In accordance with another aspect of the present invention, there is provided a multi-object audio decoding apparatus including a receiver for receiving a bitstream including a down-mix signal generated by down-mixing a stereo foreground audio object and a stereo background audio object and a residual signal generated according to the down-mix signal, and a restorer for restoring the stereo foreground audio object and the stereo background audio object from the down-mix signal using the residual signal.

The advantages, features and aspects of the invention will become apparent from the following description of the embodiments with reference to the accompanying drawings, which is set forth hereinafter. When it is considered that detailed description on a related art may obscure a point of the present invention, the description will not be provided herein. Hereafter, specific embodiments of the present invention will be described in detail with reference to the accompanying drawings.

### ADVANTAGEOUS EFFECTS

A coding and decoding method and an apparatus thereof according to the present invention can effectively provide various audio services.

### BRIEF DESCRIPTION OF THE DRAWINGS

FIG. 1 is a diagram for describing a first concept of the present invention.

FIG. 2 is a diagram for describing a second concept of the present invention.

FIG. 3 is a diagram illustrating a first down-mix generator 203 shown in FIG. 2.

FIG. 4 is a diagram for describing a first embodiment of the present invention.

FIG. 5 is a diagram for describing a second embodiment of the present invention.

FIG. 6 is a diagram for describing a third embodiment of the present invention.

FIG. 7 is a diagram for describing a fourth embodiment of the present invention.

FIG. 8 is a diagram for describing decoding in accordance with an embodiment of the present invention.

FIG. 9 is a diagram for describing an exemplary embodiment of the present invention.

### MODE FOR THE INVENTION

### Best Mode

Following description exemplifies only the principles of the present invention. Even if they are not described or illustrated clearly in the present specification, one of ordinary skill in the art can embody the principles of the present invention and invent various apparatuses within the concept and scope of the present invention. The use of the conditional terms and embodiments presented in the present specification are intended only to make the concept of the present invention understood, and they are not limited to the embodiments and conditions mentioned in the specification.

Also, all the detailed description on the principles, viewpoints and embodiments and particular embodiments of the present invention should be understood to include structural and functional equivalents to them. The equivalents include not only currently known equivalents but also those to be developed in future, that is, all devices invented to perform the same function, regardless of their structures.

For example, block diagrams of the present invention should be understood to show a conceptual viewpoint of an exemplary circuit that embodies the principles of the present invention. Similarly, all the flowcharts, state conversion diagrams, pseudo codes and the like can be expressed substantially in a computer-readable media, and whether or not a computer or a processor is described distinctively, they should be understood to express various processes operated by a computer or a processor.

Functions of various devices illustrated in the drawings including a functional block expressed as a processor or a similar concept can be provided not only by using hardware dedicated to the functions, but also by using hardware capable of running proper software for the functions. When a function is provided by a processor, the function may be provided by a single dedicated processor, single shared processor, or a plurality of individual processors, part of which can be shared.

The apparent use of a term, ‘processor’, ‘control’ or similar concept, should not be understood to exclusively refer to a piece of hardware capable of running software, but should be understood to include a digital signal processor (DSP), hardware, and ROM, RAM and non-volatile memory for storing software, implicatively. Other known and commonly used hardware may be included therein, too.

In the claims of the present specification, an element expressed as a means for performing a function described in the detailed description is intended to include all methods for performing the function including all formats of software, such as combinations of circuits for performing the intended function, firmware/microcode and the like. To perform the intended function, the element is cooperated with a proper circuit for performing the software. The present invention defined by claims includes diverse means for performing particular functions, and the means are connected with each other in a method requested in the claims. Therefore, any means that can provide the function should be understood to be an equivalent to what is figured out from the present specification.

Other objects and aspects of the invention will become apparent from the following description of the embodiments with reference to the accompanying drawings, which is set forth hereinafter. If further detailed description on a related art is determined to obscure a point of the present invention, the description will not be provided herein. Hereafter, specific embodiments of the present invention will be described in detail with reference to the drawings.

The present invention relates to a multi-object audio coding and decoding technology. A multi-object audio may include a plurality of audio objects that construct an audio content. For example, if an audio content includes an accompaniment or background music and vocal, the accompaniment or the background music is one audio object and the vocal is another audio object. The audio object of the accompaniment or the background music may be subdivided into audio objects of musical instruments such as a piano or a drum. Multi-object audio encoding is a technology for compressing different audio objects, and multi-object audio decoding is a technology for decoding coded multi-object audio. Therefore, the multi-object audio encoding and decoding technology enables various active audio services to be provided to users by coding and decoding a plurality of audio objects by objects. That is, the multi-object audio encoding and decoding technology not only enables a user to individually control each of audio objects but also make it possible to create various audio services and contents by combining a plurality of audio objects.

In the present invention, a residual signal may be used to encode and decode the multi-object audio. The residual signal denotes a difference of a predetermined signal before and after estimation. The residual signal may be defined as Eq. 1.

X(t)−X′(t)=Xresidual(t) Eq. 1

In Eq. 1, X(t) indicates an original signal before estimation, and X′(t) denotes an estimated signal after estimation. Xresidual (t) denotes a difference between the original signal and the estimated signal.

Multi-object audio encoding using a residual signal will be described as follows. For example, in case of multi-object audio includes a first audio object and a second audio object, a down-mix signal is generated by down-mixing the first audio object and the second audio object. The first audio object and the second audio object may be estimated as a first estimated audio object and a second estimated audio object. Here, the first audio object and the second audio object are original signals, and the first estimated audio object and the second estimated audio object are estimated signals. The residual signal can be generated using the original signals and the estimated signals. Therefore, a down-mix signal and a residual signal may be generated by down-mixing first and second audio objects in multi-object audio encoding according to an exemplary embodiment of the present invention. In multi-object audio decoding according to an exemplary embodiment of the present invention, inverse processes of the multi-object audio encoding are performed. That is, a first audio object and a second audio object are restored using a down-mix signal and a residual signal.

A multi-object encoding method according to an embodiment of the present invention includes generating a down-mix signal and a residual signal by down-mixing a foreground audio object and a background audio object, and generating a bitstream including the down-mix signal and the residual signal. The foreground audio object may include a first foreground audio object and a second foreground audio object. The generating a down-mix signal and a residual signal may include generating a first down-mix signal and a first residual signal by down-mixing the background audio object and the first foreground audio object, and generating a second down-mix signal and a second residual signal by down-mixing the first down-mix signal and the second foreground audio object. The generating a down-mix signal and a residual signal may further include bypassing the second foreground audio object.

A multi-object audio encoding apparatus according to an embodiment of the present invention includes a down-mix generator for generating a down-mix signal and a residual signal by down-mixing an foreground audio object and a background audio object, and generating a bitstream including the down-mix signal and the residual signal. The foreground audio object may include a first foreground audio object and a second foreground audio object. The down-mix generator includes a first down-mix generator for generating a first down-mix signal and a first residual signal by down-mixing the background audio object and the first foreground audio object, and a second down-mix generator for generating a second down-mix signal and a second residual signal by down-mixing the first down-mix signal and the second foreground audio object. The first down-mix generator may bypass the second foreground audio object.

A multi-object audio decoding method according to an embodiment of the present invention includes receiving a bitstream including a down-mix signal generated by down-mixing a foreground audio object and a background audio object and a residual signal left after the down-mixing, and restoring the foreground audio object and the background audio object from the down-mix signal using the residual signal. The foreground audio object may include a first foreground audio object and a second foreground audio object, and the residual signal may include a first residual signal for the first foreground audio object and a second residual signal for the second foreground audio object. The restoring the foreground audio object and the background audio object may include restoring the first foreground audio object using the down-mix signal and the first residual signal and restoring the second foreground audio object using a down-mix signal and the second residual signal after restoring the first foreground audio object.

A multi-object audio decoding apparatus according to an embodiment of the present invention includes a receiver for receiving a bitstream including a down-mix signal generated by down-mixing a foreground audio object and a background audio object and a residual signal left after generating the down-mix signal and a restorer for restoring the foreground audio object and the background audio object from the down-mix signal using the residual signal. The foreground audio object may include a first foreground audio object and a second foreground audio object, and the residual signal may include a first residual signal for the first foreground audio object and a second residual signal for the second foreground audio object. The restorer may includes a first restorer for restoring the first foreground audio object using the down-mix signal and the first residual signal and a second restorer for restoring the second foreground audio object using a down-mix signal and the second residual signal after restoring the first foreground audio object.

The audio object includes a mono audio object having a mono signal and a stereo audio object having a stereo signal. The stereo audio object may include a left channel signal and a right channel signal.

The background audio object may be a down-mixed audio object generated by down-mixing a stereo audio object to a mono audio object. Or the background audio object may be a down-mixed audio object generated by down-mixing a mono audio object to a stereo audio object. Therefore, the background audio object may be a down-mixed object generated by down-mixing a plurality of mono audio objects to a stereo audio object or by down-mixing a plurality of stereo audio object to a mono audio object. Accordingly, the multi-object audio may include a plurality of background audio objects in this case. Also, the background audio object may be a down-mixed object generated by down-mixing a plurality of mono audio objects or a plurality of stereo audio objects to one stereo audio object. Accordingly, the multi-object audio may include a plurality of background audio objects in this case. Like the background audio object, the foreground audio object may be a down-mixed object generated by down-mixing a stereo audio object to a mono audio object or generated by down-mixing a mono audio object to a stereo audio object.

The multi-object audio coding and decoding technology according to an embodiment of the present invention enables an audio object to be actively controlled by encoding or decoding multi-object audio using a residual signal. Also, the multi-object audio coding and decoding technology according to an embodiment of the present invention can effectively encode and decode multi-object audio including mono or stereo audio objects.

Hereinafter, multi-object audio including a foreground audio object and a background audio object will be described. The foreground audio object denotes a target audio object to control. However, the foreground audio object may be replaced with the background audio object. Also, the foreground audio object and the background audio object may include a plurality of audio objects.

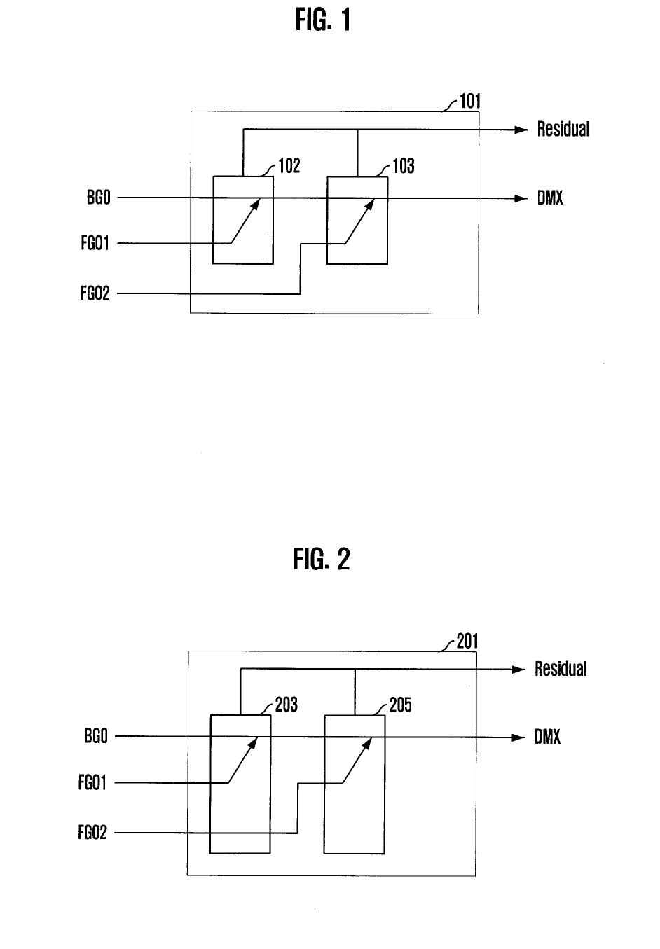

FIG. 1 is a diagram for describing a first concept of the present invention. Referring to FIG. 1, a foreground audio object FGO and a background audio object BGO are inputted to a down-mix generator 101. In FIG. 1, the foreground audio object FGO includes a first foreground audio object FGO1 and a second foreground audio object FGO2.

At first, the background audio object BGO and the first foreground audio object FGO1 are inputted to a first down-mix generator 103. The first down-mix generator 103 generates a first down-mix signal and a first residual signal by down-mixing the background audio object BGO and the first foreground audio object FGO1.

A second down-mix generator 105 receives the first down-mix signal and the second foreground audio object FGO2. The second down-mix generator 105 generates a second down-mix signal DMX and a second residual signal by down-mixing the first down-mix signal and the second foreground audio object FGO2.

Two foreground audio objects FGO1 and FGO2 are inputted in FIG. 1. However, it is obvious to those skilled in the art that more than three foreground audio objects may be inputted. If more than three foreground audio objects are inputted, the first and second down-mix generators 103 and 104 increase with connected in cascade as many as the number of increased foreground audio objects.

Except the residual signal, the first and second down-mix generators 103 and 105 receive two signals and output one down-mix signal. For example, the first down-mix generator 103 receives the background audio object EGO and the first foreground audio object FOG1 and outputs a first down-mix signal. Therefore, the first down-mix generator 103 has an Inverse One To Two (OTT-1) structure which has two inputs and one output. Here, OTT-1 is defined in view of encoding. In view of decoding, OTT-1 may be equivalent to One To Two (OTT). If they are extended to the down-mix generator 101 including the first down-mix generator 103 and the second down-mix generator 105, and if more than three foreground audio objects FGO are inputted, it may have an Inverse One To N (OTN-1) structure having a plurality of inputs N and one output. Here, the OTN-1 structure is defined in view of encoding. The OTN-1 structure may be equivalent to an One To N (OTN) structure in view of decoding. Decoding processes are performed in reverse order of the above mentioned encoding processes.

FIG. 2 is a diagram for describing a second concept of the present invention. Referring to FIG. 2, an overall structure is similar to that shown in FIG. 1. However, the first down-mix generator 203 bypasses the second foreground object FGO2, and the second down-mix generator 205 down-mixes the second foreground audio object FGO2 to a down-mix signal generated by down-mixing the background audio object BGO and the first foreground audio object FGO1.

Except the residual signal, the first down-mix generator 230 or the second down-mix generator 205 receives three signals and outputs two signals. The two output signals are the down-mix signal and the bypassed signal. For example, the first down-mix generator 203 receives a background audio object BGO, a first foreground audio object FGO1, and a second foreground audio object FGO2, and outputs a first down-mix signal and a second foreground audio object FGO2. Therefore, the first down-mix generator has an Inverse Two To Three (TTT-1) which has three inputs and two outputs. However, one of the three inputs is outputted without modification. Therefore, such a structure is referred to as trivial TTT-1 (tTTT-1). Here, tTTT-1 is defined in view of encoding. It may be equivalent to trivial Two To Three (tTTT) in view of decoding. If they are extended to a down-mix generator 201 including a first down-mix generator 203 and a second down-mix generator 205, and if more than three foreground audio objects are inputted, it may have an Inverse trivial Two To N (tTTN-1) structure which has two outputs. Here, the tTTN-1 structure is defined in view of encoding. It may be equivalent to a trivial Two To N (tTTN) in view of decoding.

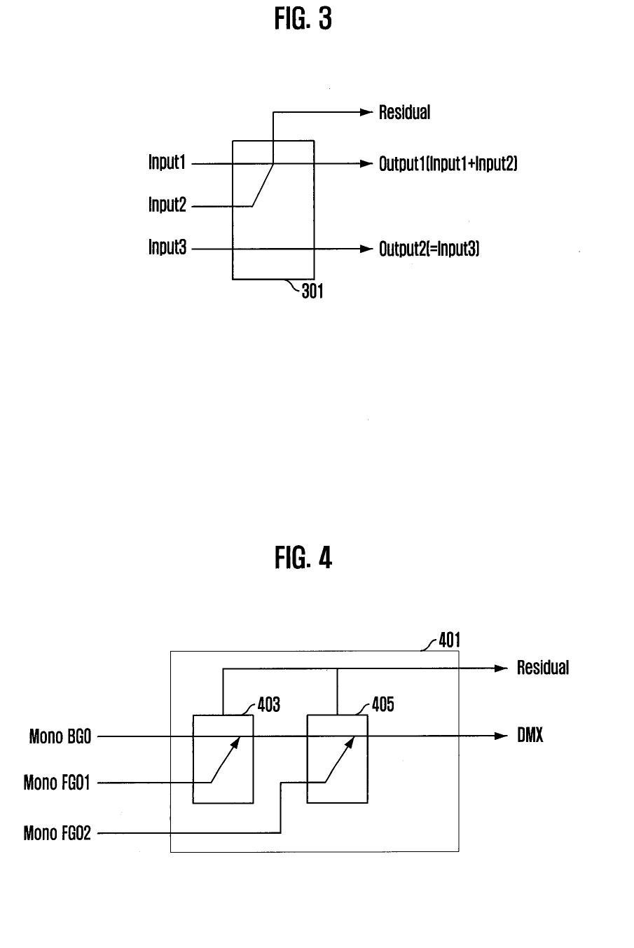

FIG. 3 is a diagram illustrating a first down-mix generator 203 shown in FIG. 2. Referring to FIG. 3, the first down-mix generator 203 receives three input signals Input 1, Input 2, and Input 3 and outputs two signals Output 1 and output 2.

The first down-mix generator 301 outputs the first output signal Output 1 as a down-mix signal by down-mixing the first input signal Input 1 and the second input signal Input 2 and generates a residual signal. The first down-mix generator 301 bypasses the third input signal as it is and outputs the bypassed signal as the second output signal Output 2. Therefore, the first output signal Output 1 is a down-mix signal generated by down-mixing the first input signal Input 1 and the second input signal Input 2. Here, the second output signal Output 2 becomes the same signal of the third input signal Input 3.

The above description may be identically applied to various embodiments of the present invention. Hereinafter, embodiments of the present invention will be described in detail with reference to drawings.

### First Embodiment

### Mono Foreground Audio Object and Mono Background Audio Object

In the first embodiment of the present invention, a foreground audio object includes a mono foreground audio object, and a background audio object includes a mono background audio object.

A multi-object audio encoding method according to the first embodiment of the present invention includes generating a down-mix signal and a residual signal by down-mixing an mono foreground audio object to a mono background audio object, and generating a bitstream including the down-mix signal and the residual signal. The mono foreground audio object may include a first mono foreground audio object and a second mono foreground audio object. The generating a down-mix signal and a residual signal may include generating a first down-mix signal and a first residual signal by down-mixing the mono background audio object and the first mono foreground audio object, and generating a second down-mix signal and a second residual signal by down-mixing the first down-mix signal and the second mono foreground audio object. The generating a down-mix signal and a residual signal may further include bypasses the second mono foreground audio object.

A multi-object audio encoding apparatus according to the first embodiment includes a down-mix generator for generating a down-mix signal and a residual signal by down-mixing an mono foreground audio object and a mono background audio object, and a bitstream generator for generating a bitstream including the down-mix signal and the residual signal. The mono foreground audio object may include a first mono foreground audio object and a second mono foreground audio object. The down-mix generator may include a first down-mix generator for generating a first down-mix signal and a first residual signal by down-mixing the mono background audio object and the first mono foreground audio object, and a second down-mix generator for generating a second down-mix signal and a second residual signal by down-mixing the first down-mix signal and the second mono foreground audio object. The first down-mix generator may bypass the second mono foreground audio object.

A multi-object audio decoding method according to the first embodiment of the present invention includes receiving a bitstream including a down-mix signal generated by down-mixing a mono foreground audio object and a mono background audio object and a residual signal left after the down-mixing, and restoring the foreground audio object and the background audio object from the down-mix signal using the residual signal. The mono foreground audio object may include a first mono foreground audio object and a second mono foreground audio object. The residual signal may include a first residual signal for the first mono foreground audio object and a second residual signal for the second mono foreground audio object. The restoring the foreground audio object and the background audio object may include restoring the first mono foreground audio object using the down-mix signal and the first residual signal, and restoring the second mono foreground audio object using a down-mix signal and the second residual signal after restoring the first mono foreground audio object.

A multi-object audio decoding apparatus according to the first embodiment includes a receiver for receiving a bitstream including a down-mix signal generated by down-mixing a mono foreground audio object and a mono background audio object and a residual signal generated according to the down-mix signal, and a restorer for restoring the mono foreground audio object and the mono background audio object from the down-mix signal using the residual signal. The mono foreground audio object may include a first mono foreground audio object and a second mono foreground audio object. The residual signal may include a first residual signal for the first mono foreground audio object and a second residual signal for the second mono foreground audio object. The restorer may include a first restorer for restoring the first mono foreground audio object using the down-mix signal and the first residual signal, and a second restorer for restoring the second mono foreground audio object using a down-mix signal and the second residual signal after restoring the first mono foreground audio object.

FIG. 4 is a diagram for describing a first embodiment of the present invention. Referring to FIG. 4, the foreground audio object FGO and the background audio object are mono signals. The mono foreground audio objects Mono FGO1 and Mono FGO2 and the mono background audio object Mono BGO are inputted to a down-mix generator 401.

A first down-mix generator 403 receives the mono background audio object Mono BOO and a first mono foreground audio object Mono FGO1 and generates a first down-mix signal and a first residual signal. A second down-mix generator 405 receives the first down-mix signal and the second mono foreground audio object Mono FGO2 and generates a second down-mix signal DMX and a second residual signal.

In FIG. 4, two mono audio objects Mono FGO1 and Mono FGO2 are inputted. However, it is obvious to those skilled in the art that more than three mono audio objects may be inputted. If more than three mono audio objects are inputted, the first and second down-mix generators 403 and 404 increase in number with being connected in cascade as many as the number of increased foreground audio objects.

If more than three foreground audio objects FGO are inputted, it may have an Inverse One To N (OTN-1) structure having a plurality of inputs N and one output. Here, the OTN-1 structure is defined in view of encoding. The OTN-1 structure may be equivalent to a One To N (OTN) structure in view of decoding. Decoding processes are performed in reverse order of the above mentioned encoding processes.

### Second Embodiment

### Stereo Foreground Audio Object and Mono Background Audio Object

In the second embodiment of the present invention, a foreground object includes a stereo foreground audio object, and a background audio object includes a mono background audio object.

A multi-object encoding method according to the second embodiment of the present invention includes generating a down-mix signal and a residual signal by down-mixing a stereo foreground audio object and a mono background audio object and generating a bitstream including the down-mix signal and the residual signal. The stereo foreground audio object may include a first signal and a second signal. The generating a down-mix signal and a residual signal may include generating a first down-mix signal and a first residual signal by down-mixing the mono sub-audio object and the first signal, and generating a second down-mix signal and a second residual signal by down-mixing the first down-mix signal and the second signal. The generating a down-mix signal and a residual signal may further include bypassing the second signal.

A multi-object audio encoding apparatus according to the second embodiment includes a down-mix generator for generating a down-mix signal and a residual signal by down-mixing a stereo foreground audio object and a mono background audio object and a bitstream generator for generating a bitstream including the down-mix signal and the residual signal. The stereo foreground audio object may include a first signal and a second signal. The down-mix generator may include a first down-mix generator for generating a first down-mix signal and a first residual signal by down-mixing the mono sub-audio object and the first signal, and a second down-mix generator for generating a second down-mix signal and a second residual signal by down-mixing the first down-mix signal and the second signal. The first down-mix generator may bypass the second signal.

A multi-object audio decoding method according to the second embodiment of the present invention includes receiving a down-mix signal generated by down-mixing a stereo foreground audio object and a mono background audio object and a residual signal left after the down-mixing, and restoring the stereo foreground audio object and the mono background audio object using the residual signal. The stereo foreground audio object may include a first signal and a second signal. The residual signal may include a first residual signal for the first signal and a second residual signal for the second signal. The restoring the stereo foreground audio object and the mono background audio object may includes restoring the first signal using the down-mix signal and the first residual signal, and restoring the second signal using a down-mix signal after restoring the first signal and the second residual signal.

A multi-object audio decoding apparatus according to the second embodiment of the present invention includes a receiver for receiving a bitstream including a down-mix signal generated by down-mixing a stereo foreground audio object and a mono background audio object and a residual signal generated according to the down-mix signal, and a restorer for restoring the stereo foreground audio object and the mono background audio object from the down-mix signal using the residual signal. Here, the stereo foreground audio object may include a first signal and a second signal. The residual signal may include a first residual signal for the first signal and a second residual signal for the second signal. The restorer may include a first restorer for restoring the first signal using the down-mix signal and the first residual signal, and a second restore for restoring the second signal using a down-mix signal after restoring the first signal and the second residual signal.

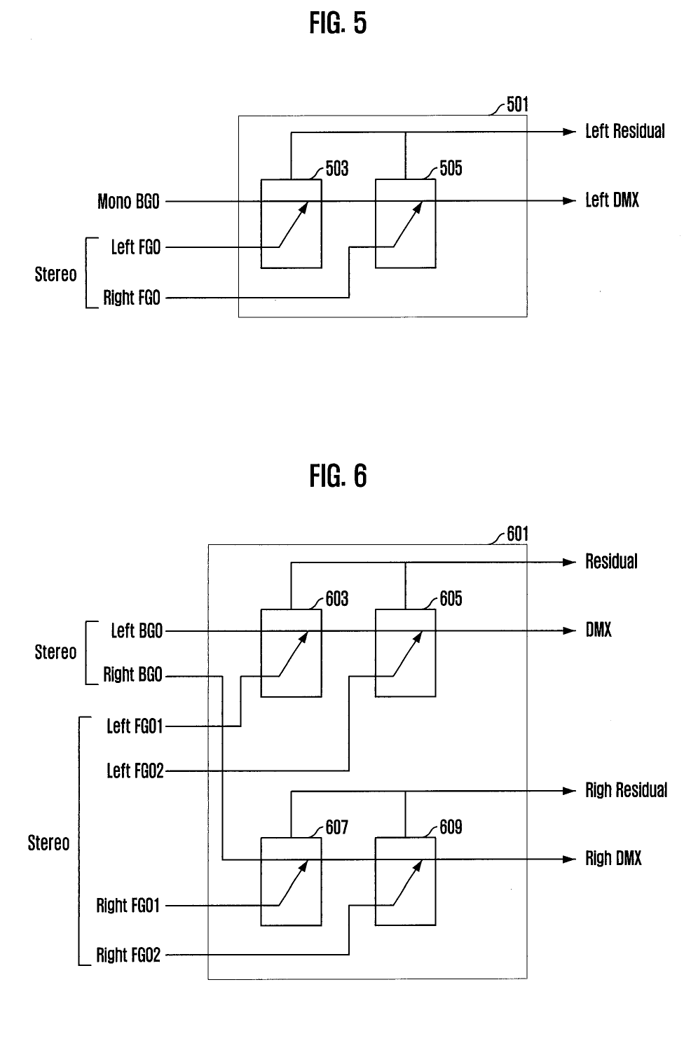

FIG. 5 is a diagram for describing a second embodiment of the present invention. Referring to FIG. 5, a down-mix generator 501 receives a mono background audio object Mono EGO and a stereo foreground audio object Stereo Left/Right FGO. The stereo foreground audio objects Stereo Left/Right FGO includes a left channel signal Left FGO and a right channel signal Right FGO.

A first down-mix generator 503 receives a mono background audio object Mono BOO and a left channel signal Left FGO and generates a first down-mix signal and a first residual signal. A second down-mix generator 505 receives a first down-mix signal and a right channel signal Right FGO and generates a second down-mix signal DMX and a second residual signal.

In FIG. 5, one stereo foreground audio object Stereo Left/Right FGO is inputted. However, it is obvious to those skilled in the art that more than two stereo foreground audio objects may be inputted. If more than two stereo foreground audio objects are inputted, the first and second down-mix generators 503 and 505 increase with being connected in cascade as many as the number of increased stereo foreground audio objects. Decoding processes are performed in reverse order of the above mentioned encoding processes.

### Third Embodiment

### Stereo Foreground Audio Object and Stereo Background Audio Object

In the third embodiment of the present invention, a foreground object includes a stereo foreground audio object, and a background audio object includes a stereo background audio object. The stereo audio object may include a left channel signal and a right channel signal.

A multi-object audio encoding method according to the third embodiment of the present invention includes generating a down-mix signal and a residual signal by down-mixing a stereo foreground audio object and a stereo background audio object, and generating a bitstream including the down-mix signal and the residual signal. Each of the stereo foreground audio object and the stereo background audio signal may include a first signal and a second signal. The generating the down-mix signal and the residual signal may include generating a first down-mix signal and a first residual signal by down-mixing the first signals of the stereo foreground audio object and the stereo background audio signal, and generating a second down-mix signal and a second residual signal by down-mixing the second signals of the stereo foreground audio object and the stereo background audio signal. The first signal of the stereo foreground audio object may include a first left channel signal and a second left channel signal. The generating a first down-mix signal and a first residual signal may includes generating a first left channel down-mix signal and a first left channel residual signal by down-mixing the first signal of the stereos background audio object and the first left channel signal, and generating a second left channel down-mix signal and a second left channel residual signal by down-mixing the first left channel down-mix signal and the second left channel signal. The generating a first down-mix signal and a first residual signal may further include bypassing the second left channel signal.

A multi-object audio encoding apparatus according to the third embodiment of the present invention includes a down-mix generator for generating a down-mix signal and a residual signal by down-mixing a stereos foreground audio object and a stereo background audio object and a bitstream generator for generating a bitstream including the down-mix signal and the residual signal. Each of the stereo foreground audio object and the stereo background audio signal may include a first signal and a second signal. The down-mix generator may include a first down-mix generator for generating a first down-mix signal and a first residual signal by down-mixing the first signals of the stereo foreground audio object and the stereo background audio signal, and a second down-mix generator for generating a second down-mix signal and a second residual signal by down-mixing the second signals of the stereo foreground audio object and the stereo background audio signal. The first signal of the stereo foreground audio object may include a first left channel signal and a second left channel signal. The first down-mix generator may includes a first left channel down-mix generator for generating a first left channel down-mix signal and a first left channel residual signal by down-mixing the first signal of the stereos background audio object and the first left channel signal, and a second left channel down-mix generator for generating a second left channel down-mix signal and a second left channel residual signal by down-mixing the first left channel down-mix signal and the second left channel signal. The first down-mix generator may bypass the second left channel signal.

A multi-object audio decoding method according to the third embodiment of the present invention includes receiving a bitstream including a down-mix signal by down-mixing a stereo foreground audio object and a stereo background audio object and a residual signal according to the down-mix signal, and restoring the stereo foreground audio object and the stereo background audio object from the down-mix signal using the residual signal. Each of the stereo foreground audio object and the stereo background audio signal may include a first signal and a second signal. The residual signal may include a first residual signal for the first signal and a second residual signal for the second signal. The restoring the stereo foreground audio object and the stereo background audio object may include restoring the first signal using the down-mix signal and the first residual signal, and restoring the second signal using the down-mix signal and the second residual signal. The first signal of the stereo foreground audio object may include a first left channel signal and a second left channel signal. The first residual signal includes a first left channel residual signal for the first left channel signal and a second left channel residual signal for the second left channel signal. The restoring the first signal includes restoring the first left channel signal using the down-mix signal and the first left channel residual signal, and restoring the second left channel signal using a down-mix signal after restoring the first left channel signal and the second left channel signal.

A multi-object audio decoding apparatus according to the third embodiment of the present invention includes a receiver for receiving a bitstream including a down-mix signal generated by down-mixing a stereo foreground audio object and a stereo background audio object and a residual signal generated according to the down-mix signal, and a restorer for restoring the stereo foreground audio object and the stereo background audio object from the down-mix signal using the residual signal. Each of the stereo foreground audio object and the stereo background audio signal may include a first signal and a second signal. The residual signal may include a first residual signal for the first signal and a second residual signal for the second signal. The restorer may include a first restorer for restoring the first signal using the down-mix signal and the first residual signal, and a second restorer for restoring the second signal using the down-mix signal and the second residual signal. The first signal of the stereo foreground audio object may include a first left channel signal and a second left channel signal. The first residual signal includes a first left channel residual signal for the first left channel signal and a second left channel residual signal for the second left channel signal. The first restorer may include a first left channel restorer for restoring the first left channel signal using the down-mix signal and the first left channel residual signal, and a second left channel restorer for restoring the second left channel signal using a down-mix signal after restoring the first left channel signal and the second left channel signal.

FIG. 6 is a diagram for describing a third embodiment of the present invention. Referring to FIG. 6, a foreground audio object Stereo Left/Right FGO is a stereo signal, and a background audio object Stereo Left/Right BGO is a stereo signal. Two stereo foreground audio objects Stereo Left/Right FGO1 and Stereo Left/Right FGO2 will be described with reference to FIG. 6.

A down-mix generator 601 receives a stereo background audio object Stereo Left/Right BGO and two stereos foreground audio objects Stereo Left/Right FGO1 and Stereo Left/Right FGO2.

A first left channel down-mix generator 603 receives the left channel background audio object Left EGO and the first left channel foreground audio object Left FGO1 and generates a first left channel down-mix signal and a first left channel residual signal Left Residual. A second left channel down-mix generator 605 receives a first left channel down-mix signal and a second left channel foreground audio object Left FGO2 and generates a second left channel down-mix signal Left DMX and a second left channel residual signal Left Residual.

A right channel background audio object Right BGO and right channel foreground audio objects Right FGO1 and Right FGO2 are also down-mixed through the above described processes.

In FIG. 6, two stereo foreground audio objects Stereo Left/Right FGO are inputted. However, it is obvious to those skilled in the art that more than three stereo foreground audio objects may be inputted. If more than three stereo foreground audio objects are inputted, the first and second left channel down-mix generators 603 and 605 increase with being connected in cascade as many as the number of increased foreground audio objects. Decoding processes are performed in reverse order of the above mentioned encoding processes.

In FIG. 6, the first left channel down-mix generator 603 receives the left channel background audio object Left BGO, the first left channel foreground audio object Left FGO1, and the second left channel foreground audio object Left FGO2, and the first left channel down-mix generator 603 bypasses the second left channel foreground audio object Left FGO2. That is, the first left channel down-mix generator has an Inverse Two To Three (TTT-1) having three inputs and two outputs. This structure is referred to as a trivial TTT-1 (tTTT-1) structure as described above. Also, more than three stereo foreground audio objects including a left channel signal and a right channel signal are inputted, it has an Inverse trivial Two To N (tTTN-1) structure having more than three inputs and two outputs. Here, the tTTN-1 structure is defined in view of encoding, and it may be equivalent to a trivial Two To N (tTTN) structure in view of decoding.

### Fourth Embodiment

### Stereo Foreground Audio Object and Mono Background Audio Object

In the fourth embodiment of the present invention, a foreground object includes a stereo foreground audio object, and a background audio object includes a mono background audio object. The stereo audio object may include a left channel signal and a right channel signal. In the fourth embodiment, the down-mix output signal is a stereo signal. In this view, the fourth embodiment is different from the second embodiment.

A multi-object audio encoding method according to the fourth embodiment of the present invention includes generating a down-mix signal and a residual signal by down-mixing a stereo foreground audio object and a mono background audio object, and generating a bitstream including the down-mix signal and the residual signal. The stereo foreground audio object may include first and second left channel signals and first and second right channel signals. The generating the down-mix signal and the residual signal may include generating a first left channel down-mix signal, a first right channel down-mix signal, and a first residual signal by down-mixing the mono background audio object, the first left channel signal, and the first right channel signal, and generating a second left channel down-mix signal, a second right channel down mix signal, and a second residual signal by down-mixing the first left channel down-mix signal, a first right channel down-mix signal, a second left channel signal, and a second right channels signal. Here, the generating a down-mix signal and a residual signal may further include bypassing the second left channel signal and the second right channel signal.

A multi-object audio encoding apparatus according to the fourth embodiment of the present invention includes a down-mix generator for generating a down-mix signal and a residual signal by down-mixing a stereo foreground audio object and a mono background audio object, and a bitstream generator for generating a bitstream including the down-mix signal and the residual signal. The stereo foreground audio object may include first and second left channel signals and first and second right channel signals. The down-mix generator may include a first left channel down-mix generator for generating a first left channel down-mix signal, a first right channel down-mix signal, and a first residual signal by down-mixing the mono background audio object, the first left channel signal, and the first right channel signal, and a second left channel down-mix generator for generating a second left channel down-mix signal, a second right channel down mix signal, and a second residual signal by down-mixing the first left channel down-mix signal, a first right channel down-mix signal, a second left channel signal, and a second right channels signal. Here, the down-mix generator may bypass the second left channel signal and the second right channel signal.

A multi-object audio decoding method according to the fourth embodiment of the present invention includes receiving a bitstream including a down-mix signal generated by down-mixing a stereo foreground audio object and a mono background audio object and a residual signal according to the down-mix signal, and restoring the stereo foreground audio object and the mono background audio object from the down-mix signal using the residual signal. The stereo foreground audio object includes first and second left channel signals and first and second right channel signals. The residual signal includes a first residual signal for the first left and right channel signals, and a second residual signal for the second left and right channel signals. The restoring the stereo foreground audio object and the mono background audio object includes restoring the first left and right channel signals using the down-mix signal and the first residual signal and restoring the second left and right channel signals using a down-mix signal after restoring the first left and right channel signals and the second residual signal.

A multi-object audio decoding apparatus according to the fourth embodiment includes a receiver for a bitstream including a down-mix signal generated by down-mixing a stereo foreground audio object and a mono background audio object and a residual signal according to the down-mix signal, and a restorer for restoring the stereo foreground audio object and the mono background audio object from the down-mix signal using the residual signal. The stereo foreground audio object includes first and second left channel signals and first and second right channel signals. The residual signal includes a first residual signal for the first left and right channel signals, and a second residual signal for the second left and right channel signals. The restorer includes a first restorer for restoring the first left and right channel signals using the down-mix signal and the first residual signal, and a second restorer for restoring the second left and right channel signals using a down-mix signal after restoring the first left and right channel signals and the second residual signal.

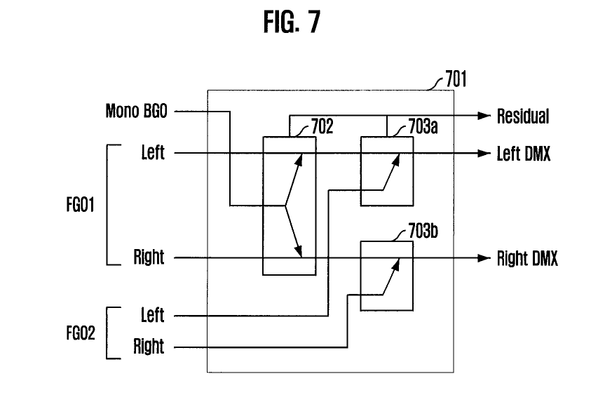

FIG. 7 is a diagram for describing a fourth embodiment of the present invention. Referring to FIG. 7, the foreground audio object is a stereo signal, and the background audio object is a mono signal. The stereo audio object may include a left channel signal and a right channel signal. A down-mix generator 701 receives a mono background audio object Mono BGO and stereo foreground audio objects FGO1 Left/Right and FGO2 Left/Right.

A first down-mix generator 702 receives the mono background audio object Mono BGO and the first stereo foreground audio objects FGO1 Left and FGO2 Right and generates a first down-mix signal and a first residual signal by down-mixing the mono background audio object Mono EGO and the first stereo foreground audio objects FGO1 Left and FGO2 Right. The first down-mix signal may include a first left channel down-mix signal and a second right channel down-mix signal. A second down-mix signal and a second residual signal are generated by down-mixing the first down-mix signal and the second stereo foreground audio objects FGO2 Left and FGO2 Right. The second down-mix signal may include a second left channel down-mix signal Left DMX and a second right down-mix signal Right DMX. A second left channel down-mix generator 703a generates a second left channel down-mix signal Left DMX by down-mixing the first left channel down-mix signal with the second stereo left channel foreground audio object FGO2 Left. A second right channel down-mix generator 703b generates a second right channel down-mix signal Right DMX by down-mixing the first right channel down-mix signal with the second stereo right channel foreground audio object FGO2 Right.

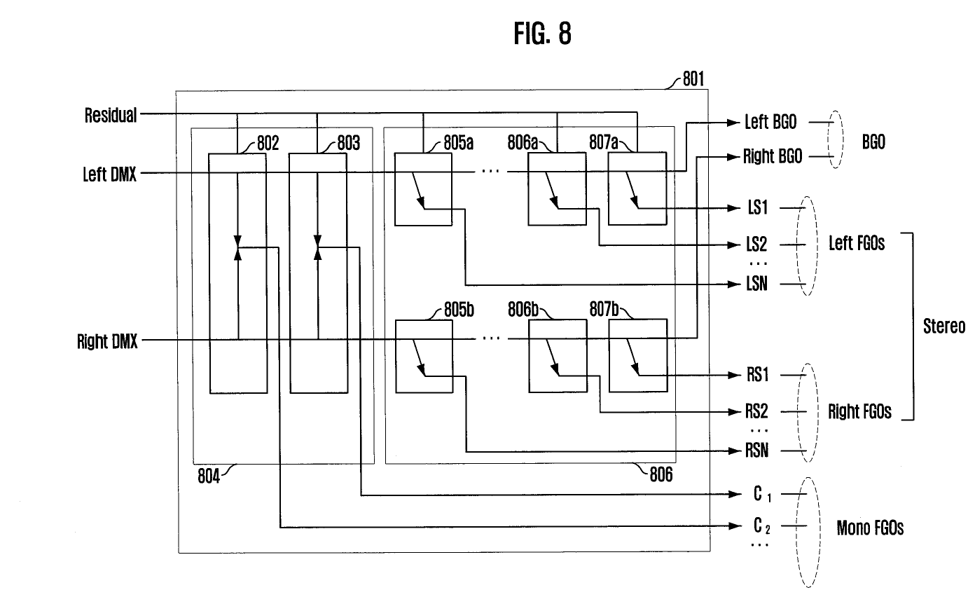

FIG. 8 is a diagram for describing decoding in accordance with an embodiment of the present invention. A bitstream including a residual signal and a down-mix signal is received, and the down-mix signal is restored. The down-mix signal may include a stereo down-mix signal having a left channel down-mix signal Left DMX and a right channel down-mix signal Right DMX.

A mono foreground audio object restorer 804 restores mono foreground objects Mono FGOs using stereo down-mix signals Left DMX and Right DMX and a residual signal Residual. The mono foreground audio object restorer 804 includes a first mono foreground audio object restorer 802 and a second mono foreground audio object restorer 803 for restoring each of the mono foreground audio objects. Here, the first mono foreground audio object restorer 802 and the second mono foreground audio object restorer 803 have a TTT structure, and the mono foreground audio object restorer 804 has a TTN structure.

A stereo foreground audio object restorer 806 restores stereo foreground objects Stereo Left/Right FGOs using the stereo down-mix signals Left DMX and Right DMX and a residual signal. The stereo foreground audio objects Stereo Left/Right FGOs include left-channel signals Left FGOs and right-channel signals Right FGOs. Finally, stereo background audio objects Left BGO and Right BGO are outputted. The stereo foreground object restorer 806 includes a plurality of object restorers 805a, 805b, . . . , 806a, 806b, 807a, and 807b. The plurality of object restorers 805a, 805b, . . . , 806a, 806b, 807a, and 807b have an OTT structure. The stereo foreground stereo object restorer 806 has an OTN structure.

FIG. 8 illustrates a decoding apparatus for a stereo background audio object and a mono foreground audio object. In case of the stereo background audio object and the mono foreground audio object, a mono background audio object and a mono foreground audio object are restored using a left channel down-mix signal Left DMX and a residual signal Residual. Meanwhile, a mono background audio object and a stereo foreground audio object may be restored by the stereo foreground audio object restorer 806. Since other decoding processes can be easily understood as shown in FIG. 8, detail description thereof is omitted.

Hereinafter, an exemplary embodiment of the present invention will be described.

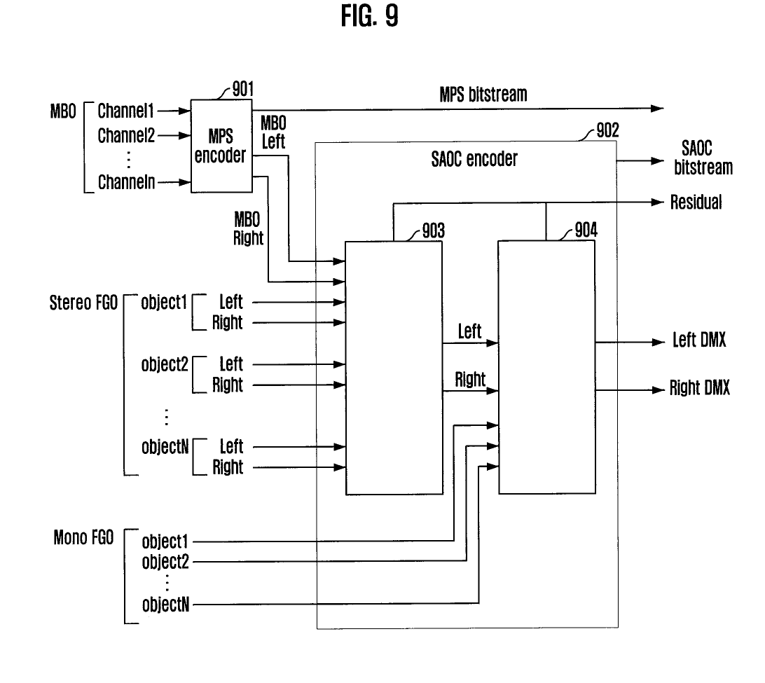

FIG. 9 is a diagram for describing an exemplary embodiment of the present invention. Referring to FIG. 9,

A multichannel Background-scene Object (MBO) includes a plurality of channels Channel 1, Channel 2, . . . , Channel n. An MPEG Surround encoder (MPS) 901 encodes MBO and outputs stereo down-mix signals MBO Left and MOB Right and a MPS bitstream which is side information. Here, the stereo down-mix signals MBO Left and MBO Right are background audio objects.

The stereo down-mix signals MBO Left and MBO Right, the stereo foreground object Stereo FGO, and the mono foreground audio object Mono FGO are inputted to a Spatial Audio Object Coding encoder (SACC). The stereo foreground audio objet Stereo FGO and the mono foreground audio object Mono FGO are foreground audio objects. The stereo foreground audio object Stereo FGO may include a plurality of stereo objects object 1, object 2, . . . , and object N, and the mono foreground audio object Mono FGO may include a plurality of mono objects object 1, object 2, . . . , and object M.

A first down-mix generator 903 generates stereo down-mix signals Left and Right and a residual signal by down-mixing the stereo down-mix signals MBO Left and MBO Right and the stereo foreground audio object Stereo FGO. Here, the first down-mix generator 903 down-mixes the stereo foreground audio object and the stereo background audio object. The first down-mix generator 903 is equivalent to the stereo down-mix generator 505 shown in FIG. 5.

A second down-mix generator 904 generates final down-mix signals Left DMX and Right DMX and a residual signal by down-mixing stereo down-mix signals Left and Right and a mono foreground audio object Mono FGO. The second down-mix generator 904 is equivalent to the down-mix generator 401 shown in FIG. 4.

A SAOC encoder 902 extracts a SAOC bitstream. A MPS bitstream, a SAOC bitstream, a residual signal, and final down-mix signals Left DMX and Right DMX are transmitted to a decoder as a bitstream.

Since decoding is a reverse operation of encoding, detail description thereof is omitted. In brief, a decoder receives a MPS bitstream, a SAOC bitstream, a residual signal, and final down-mix signal Left DMX and Right DMX. A SAOC decoder restores a foreground audio object using a residual signal and final down-mix signals Left DMX and Right DMX. A MPS decoder receives the final down-mix signals Left DMX and Right DMX generated by restoring the foreground audio object and the MPS bitstream. The MPS decoder restores a multi-channel signal of a background audio object using the MPS bitstream.

Hereinafter, generation of a residual signal will be described.

A process of generating a left channel signal and a right channel signal restored using a down-mix signal and a residual signal in a decoding operation may be described by Eq. 2.

$$[ \begin{matrix}\hat{l} \\ \hat{r}\end{matrix} ] = [ \begin{matrix}{c}_{1} & 1 \\ {c}_{2} & - 1\end{matrix} ] [ \begin{matrix}m \\ res\end{matrix} ] \qquad Eq . 2$$

In Eq. 2, a left matrix denotes a restored left channel signal and right channel signal. In a right matrix, M denotes a parameter matrix, m denotes a down-mixed signal, and res denotes a residual signal.

If the M matrix has an inverse matrix, the down-mixed signal m and the residual signal res can be obtained by Eq. 3 and Eq. 4.

$$\begin{matrix}[ \begin{matrix}m \\ res\end{matrix} ] = {[ \begin{matrix}{c}_{1} & 1 \\ {c}_{2} & - 1\end{matrix} ]}^{- 1} [ \begin{matrix}l \\ r\end{matrix} ] = \frac{1}{{c}_{1} + {c}_{2}} [ \begin{matrix}1 & 1 \\ {c}_{2} & - {c}_{1}\end{matrix} ] [ \begin{matrix}l \\ r\end{matrix} ] & Eq . 3 \\ m = \frac{l}{{c}_{1} + {c}_{2}} + \frac{r}{{c}_{1} + {c}_{2}} , res = \frac{{c}_{2} \cdot l}{{c}_{1} + {c}_{2}} - \frac{{c}_{1} \cdot r}{{c}_{1} + {c}_{2}} & Eq . 4\end{matrix}$$

The method of the present invention described above can be realized as a program and stored in a computer-readable recording medium such as CD-ROM, RAM, ROM, floppy disks, hard disks, magneto-optical disks and the like. Since the process can be easily implemented by those skilled in the art to which the present invention pertains, further description will not be provided herein.

While the present invention has been described with respect to the specific embodiments, it will be apparent to those skilled in the art that various changes and modifications may be made without departing from the spirit and scope of the invention as defined in the following claims.

### INDUSTRIAL USABILITY

An audio encoding and decoding method and an apparatus thereof according to the present invention can be used for encoding and decoding audio objects.

1. A multi-object encoding method, comprising:
generating a down-mix signal and a residual signal by down-mixing a foreground audio object and a background audio object; and
generating a bitstream including the down-mix signal and the residual signal.

2. The multi-object encoding method of claim 1, wherein the foreground audio object includes a first foreground audio object and a second foreground audio object, and
said generating a down-mix signal and a residual signal includes:
generating a first down-mix signal and a first residual signal by down-mixing the background audio object and the first foreground audio object; and
generating a second down-mix signal and a second residual signal by down-mixing the first down-mix signal and the second foreground audio object.

3. The multi-object encoding method of claim 2, wherein said generating a down-mix signal and a residual signal further includes bypassing the second foreground audio object.

4. The multi-object encoding method of claim 1, wherein the background object is a down-mixed audio object from a stereo audio object to a mono audio object.

5. The multi-object encoding method of claim 1, wherein the background audio object is a down-mixed audio object from a mono audio object to a stereo audio object.

6. The multi-object encoding method of claim 1, wherein the foreground audio object is a mono foreground audio object and the background audio object is a mono background audio object.

7. The multi-object audio encoding method of claim 1, wherein the
foreground audio object is a stereo foreground audio object and the background audio object is a mono background audio object.

8. The multi-object audio encoding method of claim 7, wherein the stereo foreground audio object includes first and second left channel signals and first and second right channel signals, and
said generating a down-mix signal and a residual signal further includes:
generating a first left channel down-mix signal, a first right channel down-mix signal, and a first residual signal by down-mixing the mono background audio object, the first left channel signal, and the first right channel signal; and
generating a second left channel down-mix signal, a second right channel down-mix signal, and a second residual signal by down-mixing the first left channel down-mix signal, the first right channel down-mix signal, the second left channel signal, and the second right channel signal.

9. The multi-object audio encoding method of claim 8, wherein said generating a down-mix signal and a residual signal further includes bypassing the second left channel signal and the second right channel signal.

10. The multi-object encoding method of claim 1, wherein the foreground audio object is a stereo foreground audio object and the background audio object is a stereo background audio object.

11. The multi-object encoding method of claim 10, wherein each of the stereo foreground audio object and the stereo background audio object includes a first signal and a second signal, and
said generating the down-mix signal and the residual signal includes:
generating a first down-mix signal and a first residual signal by down-mixing the first signals of the stereo foreground audio object and the stereo background audio object; and
generating a second down-mix signal and a second residual signal by down-mixing the second signals of the stereo foreground audio object and the stereo background audio object.

12. The multi-object audio encoding method of claim 11, wherein the first signal of the stereo foreground audio object includes a first left channel signal and a second left channel signal, and
said generating a first down-mix signal and a first residual signal includes:
generating a first left channel down-mix signal and a first left channel residual signal by down-mixing the first signal of the stereo background audio object and the first left channel signal; and
generating a second left channel down-mix signal and a second left channel residual signal by down-mixing the first left channel down-mix signal and the second left channel signal.

13. The multi-object audio encoding method of claim 12, wherein said generating a first down-mix signal and a first residual signal further includes bypassing the second left channel signal.

14. A multi-object audio encoding method, comprising:
receiving a bitstream including a down-mix signal generated by down-mixing a foreground audio object and a background audio object and a residual signal generated according to the down-mixing; and
restoring the foreground audio object and the background audio object from the down-mix signal using the residual signal.

15. The multi-object audio encoding method of claim 14, wherein the foreground audio object includes a first foreground audio object and a second foreground audio object,
the residual signal includes a first residual signal for the first foreground audio object and a second residual signal for the second foreground audio object,
said restoring the foreground audio object and the background audio object includes:
restoring the first foreground audio object using the down-mix signal and the first residual signal; and
restoring the second foreground audio object using a down-mix signal and the second residual signal after restoring the first foreground audio object.

16. The multi-object audio encoding method of claim 14, wherein the foreground audio object is a stereo foreground audio object and the background audio object is a mono background audio object.

17. The multi-object audio encoding method of claim 16, wherein the stereo foreground audio object includes first and second left channel signals and first and second right channel signals,
the residual signal includes a first residual signal for the first left and right channel signals, and a second residual signal for the second left and right channel signals,
said restoring the second signal includes:
restoring the first left and right channel signals using the first residual signal and the down-mix signal; and
restoring the second left and right channel signals using a down-mix signal after restoring the first left and right channel signals and the second residual signal.

18. The multi-object audio decoding method of claim 14, wherein the foreground audio object is a stereo foreground audio object and the background audio object is a stereo background audio object.

19. The multi-object audio decoding method of claim 18, wherein each of the stereo foreground audio object and the stereo background audio object includes a first signal and a second signal,
the residual signal includes a first residual signal for the first signal and a second residual signal for the second signal,
said restoring the stereo foreground audio object and the stereo background audio object includes:
restoring the first signal using the down-mix signal and the first residual signal; and
restoring the second signal using a down-mix signal and the second residual signal.

20. The multi-object audio decoding method of claim 19, wherein the first signal of the stereo foreground audio object includes a first left channel signal and a second left channel signal,
the first residual signal includes a first left channel residual signal for the first left channel signal and a second left channel residual signal for the second left channel signal,
said restoring the first signal includes:
restoring the first left channel signal using the down-mix signal and the first left channel residual signal; and
restoring the second left channel signal using a down-mix signal after restoring the first left channel signal and the second left channel signal.

21-35. (canceled)
